(19) United States
(12) Patent Application Publication
(10) Pub. No.: US 2013/0102368 A1
(43) Pub. Date: Apr. 25, 2013

(54) Battle Phone Case

(71) Applicant: Shanyao Lee, Irvine, CA (US)

(72) Inventor: Shanyao Lee, Irvine, CA (US)

(21) Appl. No.: 13/278,073

(22) Filed: Oct. 20, 2011

(51) Int. Cl. H04W 88/00

(52) U.S. Cl. 455/575.8

(57) ABSTRACT

A phone case for protecting a phone from damage due to accidents or mistreatment. Said phone case comprising of a quick pull loop providing for quicker and easier retrieval of phone from pocket as well as improved grip during regular phone use.

### BACKGROUND OF THE INVENTION

1. Field of Invention

This application relates to methods and mechanisms for protecting phones from damage due to accidents or mistreatment without impairing the use of the phone, particularly to methods and mechanisms for protecting so-called “smartphones” from damage.

2. Prior Art

Cell phones have become a ubiquitous part of society. As the prevalence of so called “smartphones” continues to grow, these phones have become increasingly valuable and integral to the lives of their owners. Because of this value and importance, it is more important than ever to protect these phones from damage.

Presently, those who wish to protect their phones from damage often use thin protective skins made of flexible materials to absorb the impact of any blow that might have otherwise damaged the phone encased within. These protective cases are often thin and hug the frame of the phone so that it is hard to get a grip on the case. This makes retrieving the encased phone especially difficult when it is in a person's pocket if that pocket is tight or the phone is deep within the pocket. Additionally, these phone cases can easily drop or slip because they hug the frame of the phone without providing a surface or mechanism for adequate grip.

Phone cases and skins of the prior art often leave openings for the phone's built in camera and accompanying camera flash, but these parts are then left exposed to outside forces.

There exists a need for a case or skin for phones that provides for an adequate hold of the phone and its case as well as an integral mechanism that allows the phone to be more easily retrieved from one's pocket. Additionally, there exists a need for a phone case or protective skin that provides for protection of the camera lens and camera flash mechanisms.

### OBJECTS AND ADVANTAGES

Accordingly, several objects and advantages of this invention are:
(a) to make retrieval of phone quicker and easier;
(b) to protect phone from damage due to accidents or mistreatment;
(c) to allow for more secure grip of phone during use

Further objects and advantages of this invention will become apparent from a consideration of the drawings and ensuing description.

### SUMMARY

The following summary is provided to facilitate an understanding of some of the innovative features unique to the embodiments and is not intended to be a full description. A full appreciation of the various aspects of the embodiments can be gained by taking the entire specification, claims, drawings, and abstract as a whole.

In accordance with the present invention, a protective phone case comprises a loop for quick and easy retrieval of the phone from pockets as well as improving grip on phone during use.

### DRAWINGS—FIGURES

FIG. 1 shows the a rear view perspective of the battle phone case

FIG. 2 shows the front and inside front perspective of the battle phone case

FIG. 3 shows the rear and top perspective of the battle phone case

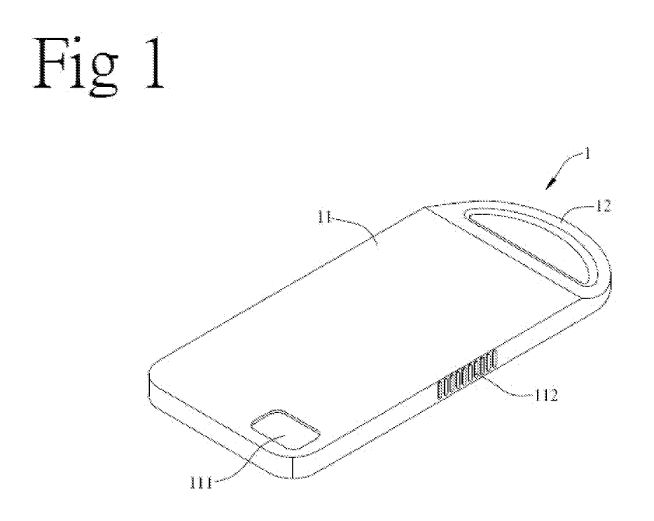

### DETAILED DESCRIPTION—FIGS. 1-3

With reference now to the drawings, the preferred embodiment of the battle phone case according to the present invention is herein described. As can be seen in FIG. 1, the outside of protective phone case 1 comprises of rear face 11, opening 111, side grip 112, and loop 12.

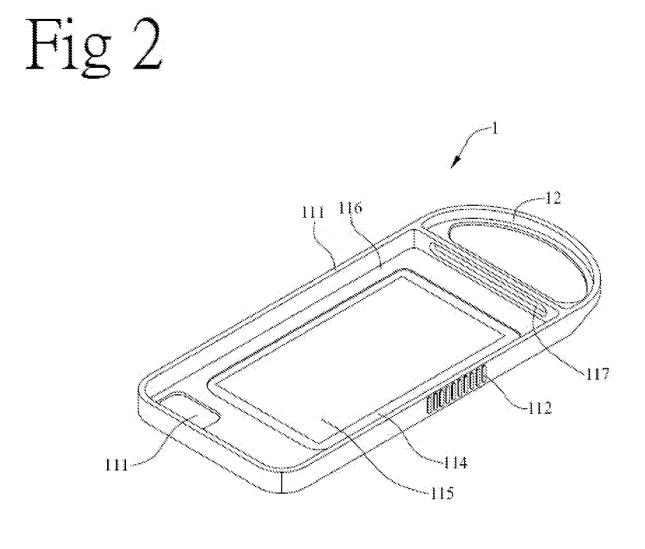

As shown in FIG. 2, in some embodiments, inside of protective phone case 1 comprises depression 114, protective insert (of a material such as Kevlar™) 115, inside back face 116, charger opening 117, and camera opening 111.

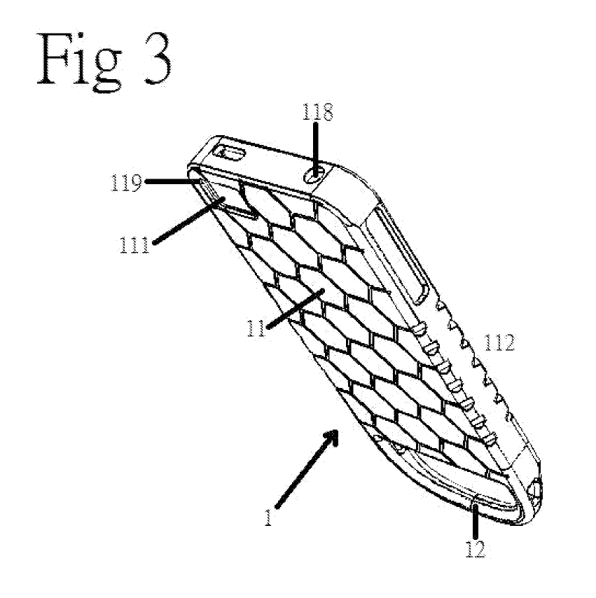

As shown in FIG. 3, in some embodiments, accessory opening 118 allows for the insertion of accessories such as ear phones, head phones, or a window punch.

As shown in FIG. 3, camera opening depression 119 allows for the insertion of a camera lens protector (not shown). Said lens protector having the property of shielding the camera elements of the phone from harmful particles and physical scratches.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

The invention may be embodied in other forms without departing from the spirit or essential characteristics thereof. The present embodiments are therefore to be considered as illustrative and not restrictive, the scope of the invention being indicated by the appended claims rather than by the foregoing description, and all changes that come within the meaning and range of equivalency of the claims are therefore intended to be embraced therein.

### Operation—FIGS. 1-3

As shown in FIG. 2, protective phone case 1 fits around phone (not shown). Phone (not shown) is inserted into protective phone case 1 such that the camera element of the phone (if one is present) shall be operable through camera opening 111, charging elements of the phone (if present) shall be operable through charger opening 117, and screen of phone shall be oriented parallel to inside back face 116.

As can be seen in FIG. 2, in some embodiments, protective insert 115 is placed within depression 114 so as to increase the protective potential of protective phone case 1.

As can be seen in FIG. 3, in some embodiments, earphones or headphones may be inserted into the phone(not shown) through accessory hole 118. In other embodiments, accessory hole 118 allows for the insertion of a window punch through accessory hole 118 such that said window punch is secured in the accessory attachment port of the phone.

### Conclusion, Ramifications, and Scope

Thus, the reader will see that the apparatus for a protective phone case with a quick pull loop provides for a more stable grip during phone use as well as quicker and easier retrieval of said phone.

While the above description contains many specifications, these should not be construed as limitations of the scope of the invention, but rather as an exemplification of a preferred embodiment of the invention. Many other variations and embodiments are possible.

Accordingly, the scope of the invention should be determined not by the embodiment illustrated, but by the appended claims and their legal equivalents.

1. A phone case, cover, or skin, comprising:
a protective covering;
a firm loop oriented in the downward position to be used as a quick pull loop and/or to aid in handling of the phone by providing extra support;
a plurality of holes, slits, breaks, and/or depressions;

2. (canceled)

3. The plurality of holes of claim 1 wherein said holes allow for the use of phone accessories, applications, or charging devices without removing accompanying phone from said case.

4. (canceled)

5. (canceled)

6. (canceled)

7. (canceled)

8. (canceled)

9. (canceled)

10. (canceled)

11. (canceled)

12. (canceled)
